(19) United States
(12) Patent Application Publication
(10) Pub. No.: US 2024/0338007 A1
(43) Pub. Date: Oct. 10, 2024

(54) NUMERICALLY CONTROLLED MACHINE TOOL FOR MACHINING MICROMECHANICAL PARTS FROM A BLANK IN THE FORM OF A BAR OR STRIP

(71) Applicant: ETA SA MANUFACTURE HORLOGÈRE SUISSE, Grenchen (CH)

(72) Inventors: Patric PHAM, Utzenstorf (CH); Christophe DONZÉ, Pieterlen (CH)

(73) Assignee: ETA SA MANUFACTURE HORLOGÈRE SUISSE, Grenchen (CH)

(21) Appl. No.: 18/612,231

(22) Filed: Mar. 21, 2024

(30) Foreign Application Priority Data
Apr. 6, 2023 (EP) 23167070.4

(51) Int. Cl. G05B 19/4093; G05B 19/18

(52) U.S. Cl. CPC G05B 19/40938; G05B 19/182

(57) ABSTRACT

A numerically controlled machine tool (10) for machining micromechanical parts from a blank (100) in the form of a bar or strip, including a frame (12), a part carrier unit (11) intended to hold the part (100) in position and a tool carrier unit (13) intended to carry a cutting tool (130), the part carrier unit (11) being kinematically connected to the frame (12) so as to have, with respect to the frame (12), only one rotational degree of freedom and one translational degree of freedom in a direction Z, in a reference frame XYZ, and the tool carrier unit (13) being kinematically connected to the frame (12) so as to have, with respect to the frame (12), only one translational degree of freedom in a direction X, and one rotational and translational degree of freedom in a direction Y.

### CROSS REFERENCE TO RELATED APPLICATIONS

This application claims priority to European Patent Application No. 23167070.4 filed Apr. 6, 2023, the entire contents of which are incorporated herein by reference.

### TECHNICAL FIELD OF THE INVENTION

The invention falls within the field of numerically controlled machine tools, and relates in particular to a numerically controlled machine tool for machining micromechanical parts from a blank in the form of a bar or strip.

In this text, the term “bar” means any solid or hollow wire, profile or tube, regardless of the shape of its cross-section.

### TECHNOLOGICAL BACKGROUND

In the field of micromechanics, reducing the dimensions of numerically controlled machine tools, and in particular reducing the size of the machine tools in relation to the machining volume, offers a number of advantages, among which increased cutting and cutting tool movement speeds due to the reduced inertia of the moving masses, a reduction in the floor space required for storing said machine tools, and a reduction in the energy consumption of such machine tools.

However, reducing the dimensions of machine tools can be accompanied by a loss of static rigidity of the machine tool, that is to say the parts forming the machine tool are more prone to deformation, which is detrimental to high-precision machining, as required by micro-technical applications such as watchmaking.

The concept of “machine tool rigidity”, in the field of mechanics, characterises the dimensional stability of the parts forming the machine tool under the effect of a thermal gradient or mechanical stress, in particular the parts forming the kinematic path between the part to be machined and the cutting tool passing through the parts forming the machine tool, that is to say the force loop.

### SUMMARY OF THE INVENTION

The invention overcomes the aforementioned disadvantages and to this end relates to a numerically controlled machine tool for machining micromechanical parts from a blank in the form of a bar or strip, comprising a frame, a part carrier unit intended to hold the part in position and a tool carrier unit intended to carry a cutting tool.

In this text, the term “cutting tool” refers to any tool used to remove material from a part, whether fixed, such as a turning tool, or rotating, such as a milling tool.

The part carrier unit is kinematically connected to the frame so as to have, with respect to the frame, one degree of rotational and translational freedom in a direction Z, in a reference frame XYZ. The tool carrier unit is kinematically connected to the frame in such a way that it only has, with respect to the frame, one degree of translational freedom in a direction X and one degree of rotational and translational freedom in a direction Y.

In this text, the term “direction” refers to an axis extending in a given direction. For example, the direction X refers to the axis X or an axis parallel to the axis X.

Advantageously, the present invention allows to optimise the ratio between the size of the machine tool and that of the blank, and more particularly, allows to minimise the dimensions of the machine tool and/or maximise the dimensions of the blank.

By way of example, the machine tool is designed so that the volume of the machine tool is substantially five times greater than that of the machining zone and the volume of the blank before machining can be at least five times greater than that of the machining zone. As a result, the ratio between the volume of the machine tool and that of the blank can be equal to one.

In particular embodiments, the invention may further include one or more of the following features, taken alone or in any technically possible combination.

In particular embodiments, the part carrier unit includes a part carrier carriage connected to the frame by at least one slide fixed directly to the frame, said part carrier carriage including a part carrier module adapted to be controlled to be in a clamping state wherein it holds the part in position, or to be in a release state wherein it allows the part to be moved.

In particular embodiments, the part carrier carriage has a through opening extending in the direction Z and opening at one of its ends at the part carrier module, said opening being intended to receive the part in order to supply a machining zone of the machine tool.

In particular embodiments, the tool carrier unit includes a first carriage connected to the frame by means of at least one slide fixed directly to the frame, and extending in the direction X. The tool carrier unit includes a second carriage connected to the first carriage and comprising a tool carrier that can move in rotation and in translation in the direction Y.

In particular embodiments, the second carriage is mounted on at least one slide fixed to the first carriage extending in the direction Y, the tool carrier being movable in rotation relative to the second carriage.

In particular embodiments, the machine tool includes an additional unit kinematically connected to the frame so as to have only one degree of rotational and translational freedom in the direction Z. The additional unit is arranged so that the cutting tool is interposed between the part carrier unit and said additional unit, the latter including an additional carriage arranged opposite the part carrier unit and receiving a part counter-carrier module intended to immobilise or release a part, or receiving a secondary tool carrier intended to carry a cutting tool.

In particular embodiments, the additional carriage has a through opening extending in the direction Z and opening at one of its ends at the part counter-carrier module, the through opening being intended to receive the part in order to extract it from a machining zone of the machine tool.

In particular embodiments, the additional carriage is mounted on at least one slide fixed to the frame, the slides to which the part carrier carriage and the additional carriage are connected being formed by the same slides.

In particular embodiments, both the part carrier module and the part counter-carrier module can include a positioning device, intended to guide the part when it is moved, or to hold the part in position.

In particular embodiments, the machine tool comprises a second tool carrier unit similar to the tool carrier unit, arranged symmetrically to the latter with respect to a plane of symmetry YZ, so that said tool carrier units are respectively on either side of the part carrier unit and the additional unit.

### BRIEF DESCRIPTION OF THE FIGURES

Other features and advantages of the invention will become apparent from the following detailed description, which is given by way of non-limiting example, with reference to the appended drawings wherein:

FIG. 1 shows a perspective view of a variant of a machine tool according to a preferred embodiment of the invention, wherein the blank to be machined is in the form of a bar;

FIG. 2 shows a perspective view of another variant of the machine tool of FIG. 1, wherein the blank to be machined is in the form of a strip;

FIG. 3 shows a front view of the machine tool of FIG. 1;

FIG. 4 shows a cross-sectional view along axis A-A of a detail of the machine tool of FIG. 3.

Note that the figures are not necessarily drawn to scale for reasons of clarity.

### DETAILED DESCRIPTION OF THE INVENTION

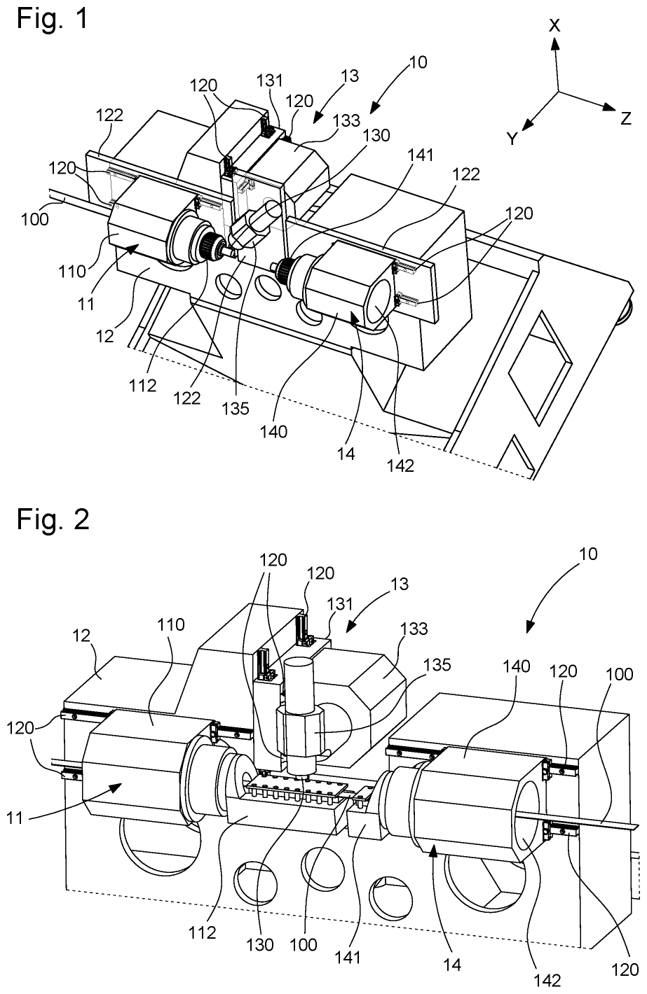

The numerically controlled machine tool 10 according to the invention is adapted for machining micromechanical parts from a blank to be machined in the form of a bar, as shown in FIG. 1, or in the form of a strip, as shown in FIG. 2. In a manner known to the person skilled in the art, the machine tool 10 includes a monitoring and control unit, such as a microcontroller, intended to receive instructions in the form of a computer program and to control the components of the machine tool 10 in accordance with these instructions. As driving the various components of the machine tool 10 is within the reach of a person skilled in the art and is not as such the subject of the present invention, these aspects are not discussed in greater detail in the present text.

In a preferred application of the invention, the machine tool 10 is adapted to obtain parts specific to the watchmaking field, in particular push-pieces, crowns, screws, shafts, pinions, etc. when the blank is in the form of a bar, and bridges, plates, rockers, middles, balance wheels, bracelet links, etc. when the blank is in the form of a strip. The blank is moved so as to feed a machining zone of the machine tool 10 in order to machine parts from said blank, one after the other. To simplify the reading of this text, a blank and a part being machined or the machining of which has been completed are referred to by the same term “part” 100.

As shown in the figures, the machine tool 10 includes a part carrier unit 11 intended in particular to hold the part 100 in position during machining. The part carrier unit 11 is kinematically connected to a frame 12 so as to have only one degree of rotational freedom and one degree of translational freedom in a direction Z in an orthonormal reference frame XYZ. As illustrated in FIGS. 1 to 3, the part carrier unit 11 is configured to hold the part 100 in a position such that it extends longitudinally in the direction Z. This feature allows to limit the inertia of the moving elements when the part carrier unit 11 moves.

The degree of rotational freedom of the part carrier unit 11 advantageously enables it to be driven so as to perform turning operations on the part 100, or so as to perform milling operations in different angular positions of the part 100. By way of example, the part carrier unit 11 can be configured to drive the part 100 at up to more than 8000 rpm, for example, up to 20000 rpm, during turning operations. It goes without saying that turning operations are only suitable for a part 100 in bar form.

In the present invention, the frame 12 is formed by the rigid structural elements of the machine tool 10. Thanks to the features of the invention, the frame 12 can be relatively compact, as shown in the figures.

The machine tool 10 also includes a tool carrier unit 13 intended to carry a cutting tool 130 and kinematically connected to the frame 12 so as to have only one degree of translational freedom in the direction X, one degree of rotational freedom and one degree of translational freedom in the direction Y.

Thus, the machine tool 10 includes five degrees of mobility, three of which are specific to the tool carrier unit 13 and two of which are specific to the part 100. The majority of movements are therefore made by the assembly with the lowest mass, that is to say by the tool carrier unit 13. Moreover, from a kinematic point of view, it was sought to limit the number of degrees of translational freedom of the tool carrier unit 13 to two in order to limit the total mass of the moving elements and thus minimise the stresses related to inertia so as to be able to use relatively compact connection elements, as described in more detail below.

Overall, these arrangements also allow to minimise the number of connection elements interposed respectively between the tool carrier 13 and part carrier 11 units and the frame 12, which has the advantage of allowing rigid construction of the machine tool 10 while minimising its volume and mass.

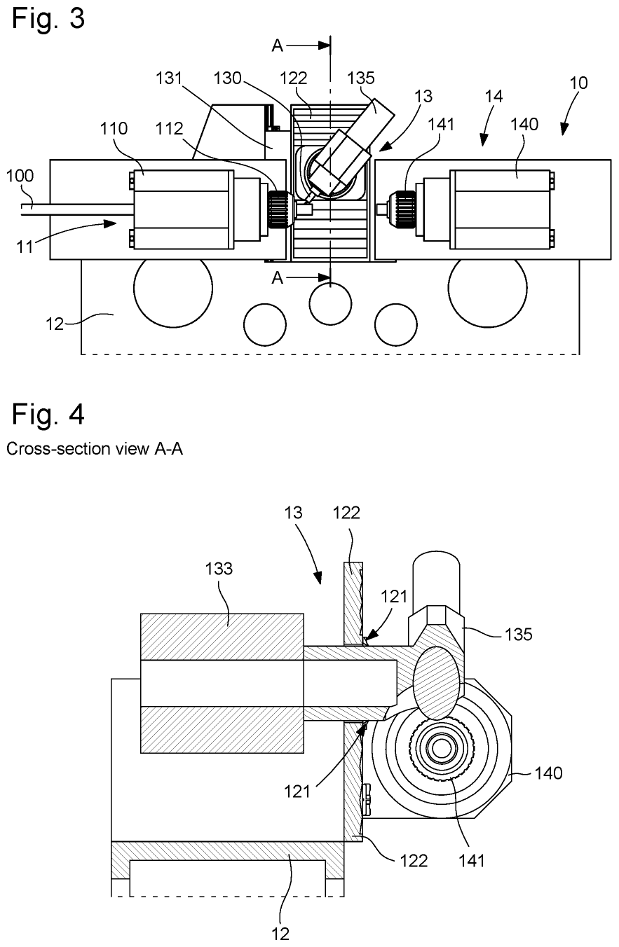

In particular, the part carrier unit 11 includes a part carrier carriage 110 mounted on at least one slide 120 fixed directly to the frame 12. The part carrier carriage 110 includes a part carrier module 112, for example formed by a chuck as shown in FIGS. 1 and 3, or by a positioning device, as shown in FIG. 2. In a known manner, the part carrier module 112 is adapted to be driven to be in a clamping state wherein it holds the part 100 in position, or to be in a release state wherein it allows the part 100 to move. The part carrier carriage 110 has a through opening extending in the direction Z, through which the part 100 is intended to be guided in order to feed the machining zone of the machine tool 10. It is understood here that the opening opens at one of its ends at the part carrier module 112.

Furthermore, the tool carrier unit 13 includes a first carriage 131 mounted on at least one slide 120 fixed directly to the frame 12 and extending in the direction X. The tool carrier unit 13 also includes a second carriage 133 mounted on at least one slide 120 fixed to the first carriage 131 and extending in the direction Y. The second carriage 133 includes a tool carrier 135 as shown in FIGS. 1 to 4, that can move in rotation about the direction Y, such as a tool carrier spindle.

As shown in FIGS. 1 and 2, the direction X is oriented vertically, that is to say in the direction of gravity. The first carriage 131 is therefore likely to be subjected to greater forces than the second carriage 133 in so far as these forces are related to the mass of the elements that the first and second carriages 131 and 133 respectively support. The first carriage 131 is also configured to travel further than the second carriage 133, particularly in order to clear the cutting tool 130 from the machining zone.

As the first slide 131 is directly connected to the frame 12, the additional forces to which it is subjected compared to the second carriage 133, as well as its longer travel, are unlikely to affect the rigidity of the machine tool 10.

It is understood here that the arrangement of the degrees of freedom of the part carrier carriage 110 and of the first and second carriages 131 and 133 of the tool carrier unit 13 is particularly advantageous since it allows, on the one hand, to minimise the masses of the moved elements and thus to minimise the stresses to which the machine tool 10 is subjected and, on the other hand, to transmit these stresses as directly as possible to the frame 12. Thanks to these features, the machine tool 10, and in particular the tool carrier 13 and part carrier 11 units, benefit from excellent dynamic behaviour, the inertia of the moving elements being contained and the rigidity of the machine tool 10 being increased.

Thanks to the design of the machine tool 10 according to the invention, the slides 120 can be sized relatively compactly.

These features also allow to easily integrate protective walls (not shown in the figures) into the machine tool 10 to protect it from projected chips of material and machining lubricants. These protective walls are arranged so as to form a machining chamber that is substantially sealed from the outside environment. Moreover, the machining chamber can be designed to be very compact by sealingly fixing the walls, on the one hand, to the frame 12 and, on the other hand, to each carriage, for example by means of wipers 121 or bellows 122.

In particular, the bellows 122 are schematically shown in FIG. 1 as transparent so as to reveal the slides 120 in particular. FIGS. 3 and 4 show an example of a bellows 122 comprising two opposite deformable walls, one of which is extended and the other retracted according to the position occupied by the carriages. FIG. 4 also shows a wiper 121 fitted around the tool carrier 135, in particular at a cylindrical portion of the latter extending in the direction Y.

It should be noted that when the machine tool 10 is intended to perform milling operations, the tool carrier 135 is configured to rotate the cutting tool 130, that is to say the milling cutter, about its longitudinal axis. This arrangement can be implemented by commercial solutions available to the person skilled in the art. By way of example, when performing milling operations, the tool carrier 135 can be configured to rotate the cutting tool 130 about its longitudinal axis at more than 60000 rpm, for example at 70000 rpm.

The machine tool 10 may include an additional unit 14 kinematically connected to the frame 12 so as to have only one degree of translational freedom and one degree of rotational freedom in the direction Z. In a similar way to the part carrier unit 11 and as illustrated in FIGS. 1 and 2, this additional unit 14 includes an additional carriage 140 mounted on at least one slide 120 fixed directly to the frame 12. The additional unit 14 is disposed so as to be arranged, with the part carrier unit 11, on either side of the tool carrier unit 13. In other words, the cutting tool 130 is interposed between the part carrier unit 11 and the additional unit 14.

Advantageously, the slides 120 to which the part carrier carriage 110 and the additional carriage 140 are connected can be formed by the same slides. Advantageously, this feature ensures alignment between the part carrier carriage 110 and the additional carriage 140.

The additional carriage 140 is adapted to receive a part counter-carrier module 141 or a secondary tool carrier (not shown in the figures) arranged opposite the part carrier unit 11. The additional carriage 140 is intended to hold the part 100 in position, when it includes the part counter-carrier module 141, and to machine by milling or drilling the part 100 held by the part carrier module 112, when it includes the secondary tool carrier.

In particular, the part counter-carrier module 141 can be formed, for example, in the same way as described above, by a clamp or by a mandrel as shown in FIG. 1, or by a fitting device, as shown in FIG. 2.

Similarly to the part carrier carriage 110, the additional carriage 140 has a through opening 142 extending in the direction Z and opens at one of its ends at the part counter-carrier module 141. The part 100 is intended to be guided through the through opening 142 in order to be extracted from the machining zone of the machine tool 10.

Advantageously, in the example shown in FIG. 1, the part counter-carrier module 141 can be controlled so as to grip the part 100 held by the part carrier carriage 110, in particular by the part carrier module 112, so that the latter, after being released by said part carrier module 112, is immobilised in position only by said part counter-carrier module 141 to enable a new machining phase to be carried out. During this new machining phase, the cutting tool 130 can then have access to zones of the part 100 that were inaccessible when it was held in position by the part carrier module 112 and can thus finalise the machining of the part 100.

Moreover, in the example shown in FIG. 2, the part 100, in this case the strip, can advantageously be held simultaneously by the part carrier module 112 and the part counter-carrier module 141. Such a positioning device is also intended, for example in combination with the part carrier positioning device, to guide the part 100 when it is moved. To this end, the positioning devices include a guideway with which the part 100 cooperates and clamping means adapted to immobilise or release the part 100.

In this exemplary embodiment of the invention, the part carrier module 112 and the part counter-carrier module 141 can be controlled to move the part 100 in a feed movement, that is to say it is translated only in one orientation in the direction Z. This feed movement of the part 100 is, for example, carried out before a machining phase and at the end of the latter to generate a part 100 inflow, in the form of a raw part, and outflow, in the form of a machined part 100, of the machine tool 10. More specifically, in order to move the part 100 in this feed movement, for example the part carrier module 112 or the part counter-carrier module 141 is driven so as to hold the part 100 while the other module is driven to release it, then the module holding the part is translated in the direction Z in a given orientation. This module is then driven so as to release the part 100 while the other module is driven to hold the part.

The part carrier module 112 and the part counter-carrier module 141 can also be driven to move the part 100 during a machining phase. More specifically, the part carrier module 112 and the part counter-carrier module 141 are both driven in this case in identical translational movements, and possibly rotational movements, to incline the part 100 in the direction Z, in particular when the part 100 is in the form of a bar.

When the additional carriage 140 receives a secondary tool carrier, the latter is adapted to carry a cutting tool, such as a milling tool or a turning tool, so that the additional unit 14 allows turning and milling operations to be carried out on a part immobilised by the tool carrier module 112.

As shown in FIGS. 1 and 2, in the preferred embodiment of the invention, the part carrier carriage 110, the first carriage 131, the second carriage 133 and the additional carriage 140 are supported by two slides 120.

Advantageously, it can be considered that the machine tool includes a second tool carrier unit similar to the tool carrier unit 13, arranged symmetrically to the latter with respect to a plane of symmetry YZ, so that said tool carrier units are located respectively on either side of the part carrier unit 11 and the additional unit 14. This feature is advantageous in that it allows machining operations to be carried out simultaneously on parts held in position by the part carrier unit 11 and by the additional unit 14. The second tool carrier unit is similar to the tool carrier unit 13 in that it also has a tool carrier unit intended to carry a cutting tool and kinematically connected to the frame 12 with identical degrees of freedom to the tool carrier unit 13.

More generally, it should be noted that the implementations and embodiments considered above have been described by way of non-limiting examples, and that other variants are therefore possible.

In particular, the exemplary embodiments shown in FIGS. 1 and 2 and described above relate to a machine tool 10 which is supplied by guiding a part 100 through a machining zone. However, the machine tool 10 according to the invention can be adapted to machine the part 100 in the form of batches, for example plots, the supply of which is carried out sequentially, each machined part 100 coming from a different blank 100.

The secondary tool carrier can moreover carry a fixed or rotating tailstock.

It should be noted that the translational and rotational movements of the part carrier 11 and tool carrier 13 units, and of any additional unit 14, are ensured, in a manner known to the person skilled in the art, by independent electric motors servo-controlled by the monitoring and control unit.

1. A numerically controlled machine tool (10) for machining micromechanical parts from a blank (100) in the form of a bar or strip, comprising a frame (12), a part carrier unit (11) intended to hold the part (100) in position and a tool carrier unit (13) intended to carry a cutting tool (130), wherein:
the part carrier unit (11) is kinematically connected to the frame (12) so as to have, with respect to the frame (12), one degree of rotational freedom and one degree of translational freedom in a direction Z, in a reference frame XYZ, and
the tool carrier unit (13) is kinematically connected to the frame (12) so as to have, with respect to the frame (12), only one degree of translational freedom in a direction X, and one degree of rotational and translational freedom in a direction Y.

2. The machine tool (10) according to claim 1, wherein the part carrier unit (11) includes a part carrier carriage (110) connected to the frame (12) by means of at least one slide (120), said part carrier carriage (110) including a part carrier module (112) adapted to be controlled to be in a clamping state wherein it holds the part (100) in position, or to be in a release state wherein it allows the part (100) to be moved.

3. The machine tool (10) according to claim 2, wherein the part carrier carriage (110) has a through opening extending in the direction Z and opening at one of its ends at the part carrier module (112), said opening being intended to receive the part (100) in order to supply a machining zone of the machine tool (10).

4. The machine tool (10) according to of claim 1, wherein the tool carrier unit (13) includes a first carriage (131) connected to the frame (12) by means of at least one slide (120) extending in the direction X, and a second carriage (133) connected to the first carriage (131) and including a tool carrier (135) that can move in rotation and in translation in the direction Y.

5. The machine tool (10) according to claim 4, wherein the second carriage (133) is mounted on at least one slide (120) fixed to the first carriage (131) and extending in the direction Y.

6. The machine tool (10) according to claim 1, further comprising an additional unit (14) kinematically connected to the frame (12) so as to have only one degree of rotational freedom and one degree of translational freedom in the direction Z, the additional unit (14) being arranged so that the cutting tool (130) is interposed between the part carrier unit (11) and said additional unit (14), and including an additional carriage (140) arranged opposite the part carrier unit (11) and receiving a part counter-carrier module (141) intended to immobilise or release a part (100) or receiving a secondary tool carrier intended to carry a cutting tool (130).

7. The machine tool (10) according to claim 6, wherein the additional carriage (140) has a through opening (142) extending in the direction Z and opening at one of its ends at the part counter-carrier module (141), the through opening (142) being intended to receive the part (100) in order to extract it from a machining zone of the machine tool (10).

8. The machine tool (10) according to claim 6, wherein the part carrier unit (11) includes a part carrier carriage (110) connected to the frame (12) by means of at least one slide (120), said part carrier carriage (110) including a part carrier module (112) adapted to be controlled to be in a clamping state wherein it holds the part (100) in position, or to be in a release state wherein it allows the part (100) to be moved, and wherein the additional carriage (140) is mounted on at least one slide (120) fixed to the frame (12), the slides (120) to which the part carrier carriage (110) and the additional carriage (140) are connected being formed by the same slides.

9. The machine tool (10) according to claim 6, wherein the part carrier unit (11) includes a part carrier carriage (110) connected to the frame (12) by means of at least one slide (120), said part carrier carriage (110) including a part carrier module (112) adapted to be controlled to be in a clamping state wherein it holds the part (100) in position, or to be in a release state wherein it allows the part (100) to be moved, and wherein both the part carrier module (112) and the part counter-carrier module (141) can include a positioning device, intended to guide the part (100) when it is moved, or to hold the part (100) in position.

10. The machine tool (10) according to claim 6, further comprising a second tool carrier unit similar to the tool carrier unit (13), arranged symmetrically to the latter with respect to a plane of symmetry YZ, so that said tool carrier units are respectively on either side of the part carrier unit (11) and the additional unit (14).
